(19) United States
(12) Patent Application Publication
(10) Pub. No.: US 2008/0228529 A1
(43) Pub. Date: Sep. 18, 2008

(54) Context Adaptive Patient Medical Data Access and Viewing System

(75) Inventors: Diana F. Willson, Durango, CO (US); Hilari K. Jones, Salt Lake City, UT (US); Ellen Elizabeth Weber, Salt Lake City, UT (US); Rex Wendell Maughan, Murray, UT (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/036,451

(22) Filed: Feb. 25, 2008

Related U.S. Application Data
(60) Provisional application No. 60/895,185, filed on Mar. 16, 2007.

(51) Int. Cl. G06Q 50/00

(52) U.S. Cl. 705/3; 705/2

(57) ABSTRACT

A system provides unlimited, user-defined “mini views” of predetermined or user selected clinical data sets. A system provides a user with an adaptive view of patient specific medical data during operation of an executable clinical information application. A context processor identifies context data associated with an executable clinical information application being employed by a user. The context data includes a patient identifier and a user identifier. A configuration processor enables a user to indicate preferred predetermined types of medical information to be accessible and displayed via a reference display image window. At least one repository stores information provided by the configuration processor, associating, for multiple different users, a user identifier with preferred predetermined types of medical information to be displayed in a reference display image window for a particular user. A user interface processor employs at least one repository for initiating generation of data representing a composite display image including and concurrently presenting a first image provided by the clinical information application and a reference display image window as an overlay of the first image. The reference display image window includes displayed user interface elements enabling user initiation of display of predetermined types of medical information of a particular patient selected in response to a patient identifier and user identifier provided by the context processor.

This is a non-provisional application of provisional application Ser. No. 60/895,185 filed Mar. 16, 2007, by R. W. Maughan et al.

### FIELD OF THE INVENTION

This invention concerns a system for providing a user with an adaptive context sensitive view of patient specific medical data during operation of an executable clinical information application.

### BACKGROUND OF THE INVENTION

Clinicians access patient clinical data during a decision making process and associated workflow (task sequence). In known systems a clinician generally needs to view pertinent data using an electronic medical record accessing application, prior to initiating execution of another application. This is because, for data integrity purposes, applications typically do not support a user in exiting and subsequently resuming a clinical application process. An image provided by a stand-alone application may display useful information at one time but may not necessarily support a clinician's thought process and workflow because it is limited to stand-alone operation. For example, if a clinician is placing a new order for medication to be administered to a patient and desires to view patient data, the clinician needs to exit an Order Entry application, access a patient medical record to review patient data, resume an Order Entry process and begin entering the medication order again.

Known systems also often pre-guess what data a clinician might need from within specific applications. In contrast, with a traditional paper medical record, a clinician thumbed through a patient medical chart or reviewed printed reports to see relevant data. If a physician is writing an order for medication to be administered to a patient using the chart and forgot to check the most recent patient laboratory test values, the physician simply paged through the chart or called the laboratory to obtain this information and returned to the orders page of the chart to continue writing orders. Electronic patient records that replace paper charts lack on-demand data access capability, flexibility and user friendliness of the paper chart record and associated chart-based clinician decision making and workflow process.

Known electronic systems access individual executable applications (e.g., associated with laboratory test results, radiology, electronic patient records medication administration) to access data specific to the individual applications. The individual applications may also include, for example, an Order Review application to view orders and a Nurse Charting application to view patient vital signs, assessments and intake and output data. A clinician may access a portal or “summary screen” that is divided into sections, each of which contains a different, predetermined subset of patient data. A clinician may also be presented with a link to information that has previously been determined as likely to be useful in the context of another application. For example, particular laboratory test results may be linked to specific medication orders. In addition, known electronic systems may allow a clinician to temporarily save work in progress to support exiting an application to seek external data and subsequently resuming an original task using the application. For example, a physician placing an order may temporarily save data, exit the application to view laboratory test results, and resume operation of the ordering application to finish the order.

However, known electronic systems fail to support a clinician workflow and decision making process since a clinician needs to see a variety of information in the context of their work. Interruption of operation of a first application following saving data, to navigate to access data from a second application, disrupts a seamless workflow. Summary image screens consolidate a variety of data so that a clinician does not need to access different applications; however, screen space limits the number of individual data sets that can concurrently be displayed on the screen. For example, a system may support just four unique quadrants of data. In addition, summary screens are provided by standalone applications, which means the data typically cannot be viewed within the context of other applications. This involves the disruption resulting from a user exiting and resuming application operation in navigating to access other data. Further, known electronic systems pre-guess the data that is to be available within an application. While well-intentioned, this approach fails to support the decision making processes of clinicians. Clinicians often desire to see certain laboratory test values while placing specific medication orders, but they may also want to view laboratory test results in the context of the latest vital signs and the last three days of fluid balance, for example. The additional information needed is specific to a patient, and clinicians may need to compile multiple sources of data to make decisions about a given medication order. Known electronic systems fail to accurately pre-guess the data a clinician needs to view.

Further, the saving of work in progress in known systems may cause significant errors since a clinician may not remember that work was not permanently saved and the work may be lost or not completed or may be completed inaccurately. Also, temporarily saving data complicates the decision making process and the workflow of clinicians that do not want to put their thought processes on hold. A system according to invention principles addresses these deficiencies and associated problems.

### SUMMARY OF THE INVENTION

A system provides unlimited, user-defined “mini views” of clinical data that can be assembled into both a static screen, known as a “Quick Overview” (QO) application, and into a dynamic pop-up window, known as a “Quick Reference” (QR) application. A system provides a user with an adaptive view of patient-specific medical data during operation of an executable clinical information application. A context processor identifies context data associated with an executable clinical information application being employed by a user. The context data includes an identifier of a patient and a user identifier. A configuration processor enables a user to indicate preferred predetermined types of medical information to be accessible and displayed via a reference display image window. At least one repository stores information provided by the configuration processor, associating, for multiple different users, a user identifier with preferred predetermined types of medical information to be displayed in a reference display image window for a particular user. A user interface (UI) processor employs the at least one repository for initiating generation of data representing a composite display image including and concurrently presenting a first image provided by the clinical information application and a reference display image window as an overlay of the first image. The reference display image window includes displayed user interface elements enabling user initiation of display of predetermined types of medical information of a particular patient selected in response to a patient identifier and user identifier provided by the context processor.

### BRIEF DESCRIPTION OF THE DRAWING

FIG. 1 shows a system for providing a user with an adaptive view of patient specific medical data during operation of an executable clinical information application, according to invention principles.

FIG. 2 shows a user interface display image presenting a Quick Overview of patient-specific medical data, including mini-views of data in different image quadrants, according to invention principles.

FIG. 3 shows a user interface display image window supporting access to a Quick Reference image from an Order Entry application, according to invention principles.

FIG. 4 shows a Quick Reference user interface pop-up image window, according to invention principles.

FIG. 5 illustrates expanded navigation options in a Quick Reference user interface pop-up image window, according to invention principles.

FIG. 6 shows a user interface display image for use selecting mini data views and a time frame for Quick Overview display image quadrants, according to invention principles.

FIG. 7 illustrates an ordered laboratory test result mini-view in a Quick Reference user interface pop-up image window, according to invention principles.

FIG. 8 illustrates an observation data mini-view selected from a Quick Reference user interface pop-up image window, according to invention principles.

FIG. 9 shows a system for providing a Quick Reference mini-view of data in different image quadrants, according to invention principles.

FIGS. 10 and 11 illustrate rules used for automatically adapting a display of data in Quick Reference mini-views comprising different image quadrants of a Quick Overview display image, according to invention principles.

FIG. 12 shows a flowchart of a process performed by a system for providing a user with an adaptive view of patient-specific medical data during operation of an executable clinical information application, according to invention principles.

### DETAILED DESCRIPTION OF THE INVENTION

A clinician needs to manage a large amount of patient-specific clinical data and needs substantially immediate access to relevant clinical data during a decision making or patient care process. A system provides unlimited, user-defined mini views of clinical data that can be assembled into both a static display image, e.g., a Quick Overview (QO) image, and into a dynamic pop-up window, e.g., a Quick Reference (QR) image. The QR image is a popup image window that enables a clinician to select from the same list of user-determined data sets that are available for display within the QO image. The selected data set fills the pop-up image window and a clinician may chose to view a current data set, change to a historical or trended data set view, or navigate to find detail of a single clinical observation or result, for example. The system enables a clinician to quickly access and view selected data without exiting from a task currently being performed using an executable application and without interrupting the user workflow. Thereby, the system provides data and information a clinician needs to make decisions and provide optimal clinical care. The system provides clinical data arranged in a single display image that is accessed using a stand-alone application or within a pop-up image window that is accessible from within any application and provides a flexible yet consistent view of patient information and supports different tasks of a clinician workflow. In addition, the system provides an ability to create and reuse mini data views in a variety of contexts to provide time and resource savings to a user.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

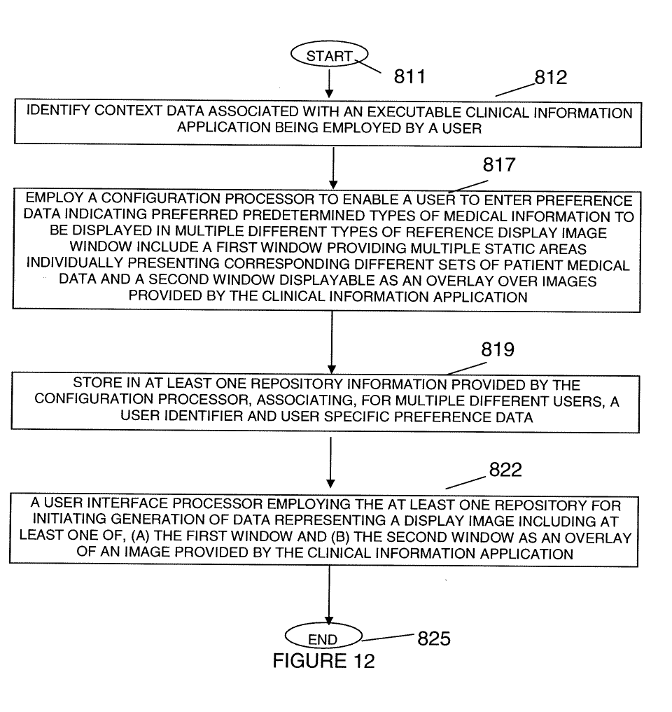

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 12) herein may be performed automatically or wholly or partially in response to user command. An activity (including a step) performed automatically is performed in response to executable instruction or device operation without user direct initiation of the activity. An object or data object comprises a grouping of data, executable instructions or a combination of both or an executable procedure. Further, a document or record comprises a compilation of data in electronic form and is the equivalent of a paper document and may comprise a single, self-contained unit of information.

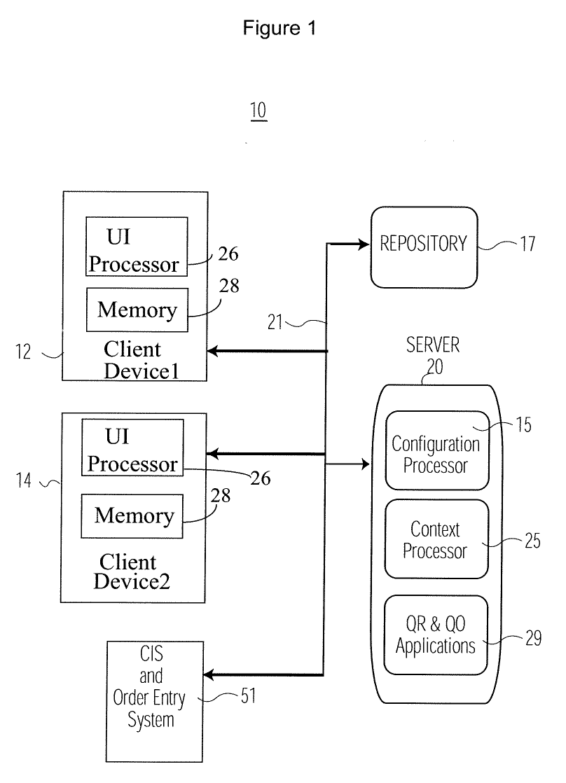

FIG. 1 shows system 10 for providing a user with an adaptive view of patient specific medical data during operation of an executable clinical information application. System 10 includes client devices (e.g., workstations. Personal Digital Assistants, cell phones) 12 and 14, repository 17, Clinical Information System (CIS) and Order Entry system 51, and server 20 inter-communicating via network 21. Server 20 includes configuration processor 15, context processor 15 and QR and QO applications 29. Client devices 12 and 14 individually include memory 28 and user interface (UI) processor 26. User interface processor 26 provides data representing display images for presentation on client device 12 and 14.

Context processor 25 identifies context data associated with executable Clinical Information System (and Order Entry application) 51 being employed by a user. The context data includes a patient identifier and a user identifier. Configuration processor 15 enables a user to indicate preferred predetermined types of medical information to be accessible and displayed via a QR reference display image window. At least one repository 17 stores information provided by configuration processor 15, associating, for multiple different users, a user identifier with preferred predetermined types of medical information to be displayed in a QR reference display image window for a particular user. User interface processor 26 employs at least one repository 17 for initiating generation of data representing a composite display image including and concurrently presenting a first image provided by Clinical Information System 51 and a reference display image window as an overlay of the first image. The reference display image window includes displayed user interface elements enabling user initiation of display of predetermined types of medical information of a particular patient selected in response to a patient identifier and user identifier provided by context processor 25.

System 10 provides a Quick Reference (QR) function that uses data presented by a static, stand-alone application (a Quick Overview (QO) application). QR and QO applications in unit 29 may alternatively be incorporated in user interface processor 26. The QR application provides access to QO data within an application so clinicians do not need to interrupt performance of a current task to view desired data. The QR application lets a clinician choose specific current and historical data to view. For instance, the QR application may not pre-guess or predetermine particular laboratory test result values to be viewed by a clinician while preparing an order for a medication to be administered to a patient. Instead, the clinician is able to select data to view to support a decision to select a medication such as fluid intake and output values, recent assessment findings, existing orders, and abnormal laboratory test values. A clinician is presented with selected data that is unique to a patient and might have been otherwise overlooked during a data review process, in response to facility-defined rules.

A Quick Overview (QO) application provides a portal-style display image comprising four quadrants (mini views) of data, for example. The mini data views available to display in each quadrant are either pre-built by the system (comprising, for example, fluid Intake and Output Summary, Orders, Abnormal/Critical Results) or are adapted from facility-defined flowsheets (e.g., including vital signs, pain assessment, wound assessment). A clinician may set preferences to determine the data presented in each quadrant of a QO display image. Within quadrant mini views, a clinician may see current data and historical data for trending purposes and may navigate to access detail concerning an individual observation or laboratory test result, for example. The static display presented in QO quadrants (e.g., four facility-determined data views) is particularly useful for evaluating and comparing different data sets at a glance.

The QR application ignores contextual constraints associated with a QO image presentation and provides hospital facility-configurable mini data views within a single popup window, at any point in a workflow (task sequence) of a worker. The QR application window includes a scrollable navigator window, which lists facility-defined mini views that a current user is authorized to access, and a data window, which shows the content of a selected mini view. The QR application window navigator frame enables user navigation to access detailed information concerning parameters presented in the mini view, in a similar manner to a QO display image. A clinician may navigate using a QR navigator function to display different mini views of interest. A QR popup display is accessible from a different (e.g., a clinical) application, without interrupting a current task or exiting the different application so a clinician has ready access to clinical data needed to make decisions. Further, clinicians may individually determine their own mini-view preferences, to include favorite flowsheet or mini-views accessible by a QR navigator and to control the order in which items appear in the QR application navigator. Hospital facilities may employ algorithms or rules based on clinical data such as medical diagnoses, nursing problems, laboratory test results or assessment results that add patient-specific flowsheets or mini-views for access using the QR application navigator.

System 10 reuses data comprising mini data views presented in a QO display image and thereby advantageously reduces time and resources expended in creating and maintaining data views. Further, the data reuse ensures a clinician is presented with a familiar layout and functions in both the static QO display image and a popup QR image window. A clinician may combine a tailored set of static quadrants in a QO display image with dynamic data access functions provided by a QR application to optimize clinical information acquisition for a workflow. A QR image window provides a single, centralized view of different types of clinical data accessed using another application different to the QR application. A clinician does not need to interrupt a current task to access a QR application and display image, and a current clinical application screen remains visible overlaid by a QR display window in the image foreground. Thereby, patient information is available to a clinician when and where it is needed. A QR application and display image provides access to system and facility configurable mini views of data that are also available and selectable for display in a QO display image quadrant, for example. A clinician may access and display a mini view of data at any time during operation of a clinical application, without exiting the clinical application. A QR display image enables a clinician to determine the clinical information displayed, regardless of a current application or task. The QR application enables a clinician to view clinical data while other work is in progress, without requiring temporarily saving data and without workflow interruption. Thereby, a clinician can find the information needed to make real-time decisions during the completion of a task.

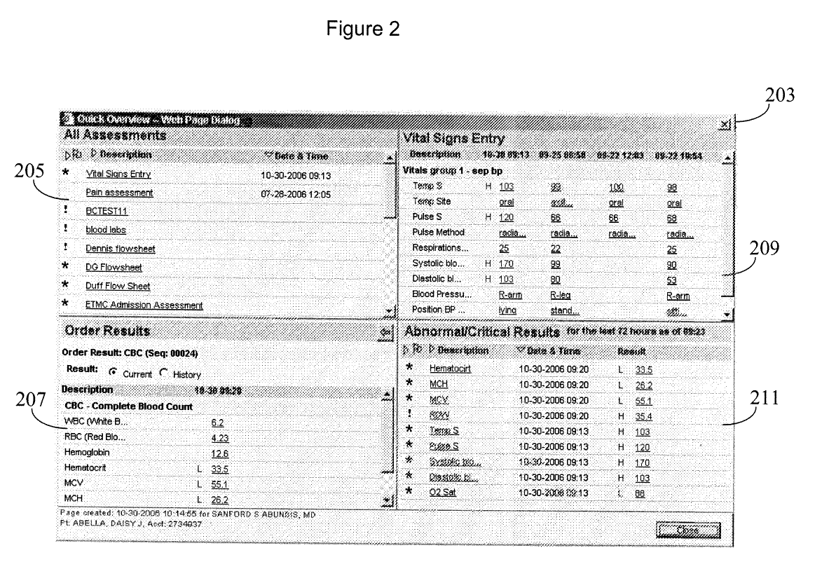

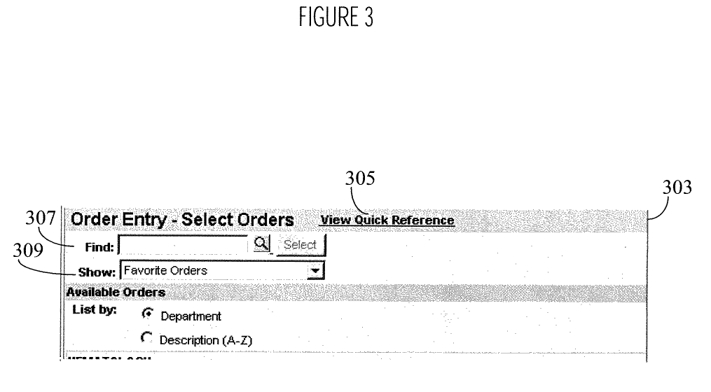

User interface processor 26 (FIG. 1) provides the display images of FIGS. 2-8 for presentation on client devices 12 and 14. FIG. 2 shows user interface display image 203 presenting a Quick Overview (QO) of patient specific medical data including mini-views of data in different image quadrants. Specifically, display image 203 includes quadrants 205, 207, 209 and 211 comprising assessments, ordered laboratory test results, vital sign parameters and abnormal/critical results, respectively. FIG. 3 shows user interface display image window 303 supporting access to a Quick Reference image from an Order Entry application. In response to user selection of link 305, a QR display image is displayed on client device 12, presenting order information. The order information comprises search result data indicating orders for medication for a particular patient that is derived by a search processor in unit 51 in response to a search term entered by a user in box 307 in a category selected in option list 309.

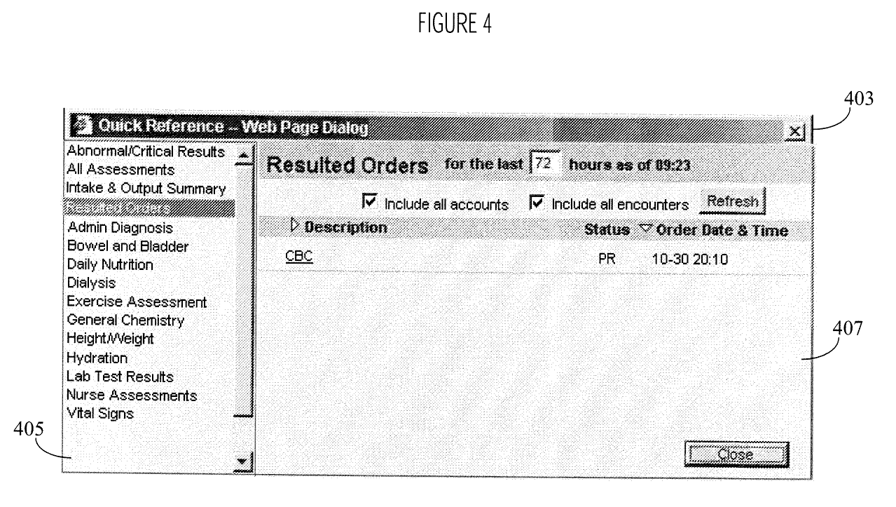

FIG. 4 shows Quick Reference user interface pop-up image window 403. The Quick Reference (QR) popup image window 403 comprises a navigation frame 405 and a viewing frame 407. Navigation frame 405 incorporates user selectable links to system and hospital facility determinable mini data views that are also used in a Quick Overview (QO) application and QO display image. A QO display image includes system determined abnormal or critical results, I&O (fluid input and output) summary data, and ordered laboratory test results as well as hospital facility determined flowsheets (charts of vital signs, for example) and user determined favorite flowsheets. QR navigator window 405 (and associated QR application) employs a predetermined sequence of elements (e.g., system-defined mini data views first, followed by facility-defined views and user-defined favorite mini data views). The navigation options provided by frame 405 support the display of expanded subcategories of information, such as different types of flowsheets within a larger category.

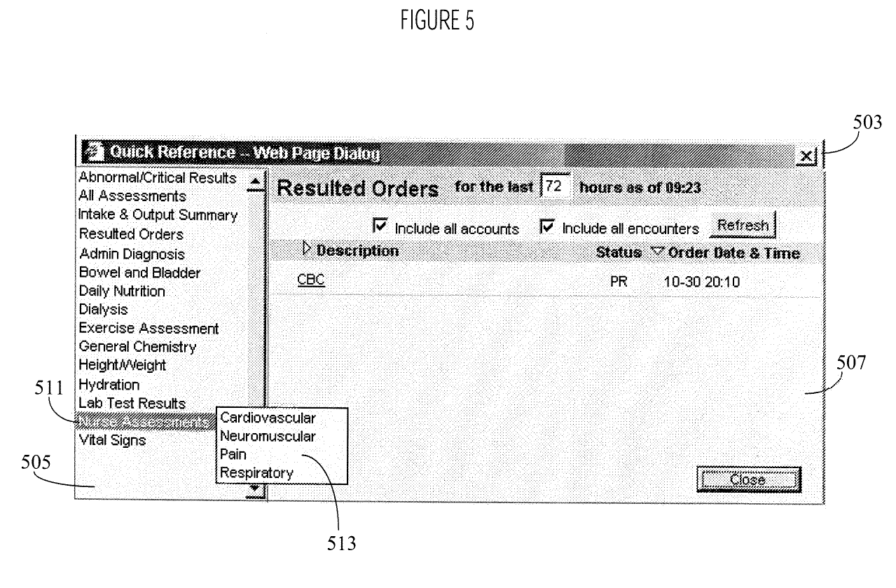

FIG. 5 illustrates expanded navigation options in Quick Reference user interface pop-up image window 503. Specifically, in response to user selection of nurse assessment item 511, expanded user selectable navigation items (cardiovascular, neuromuscular, pain and respiratory) are displayed in area 513. Navigator frame 505 is scrollable, enabling users to scan through available mini data views. In response to user selection of an item in navigator frame 505, viewing frame 507 is populated with an associated mini data view. The range of data displayed in QR viewing window 507 comprises data occurring during a timeframe selected in a user preference profile (e.g., shared with a QO display image) and associated with a current account. The timeframe is changeable and configurable to include accounts and encounters in a QR mini data view as desired.

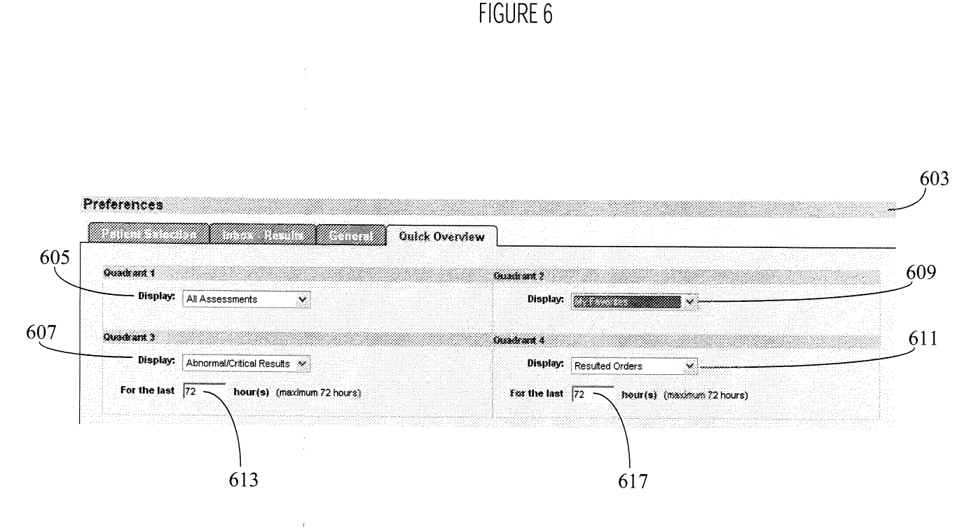

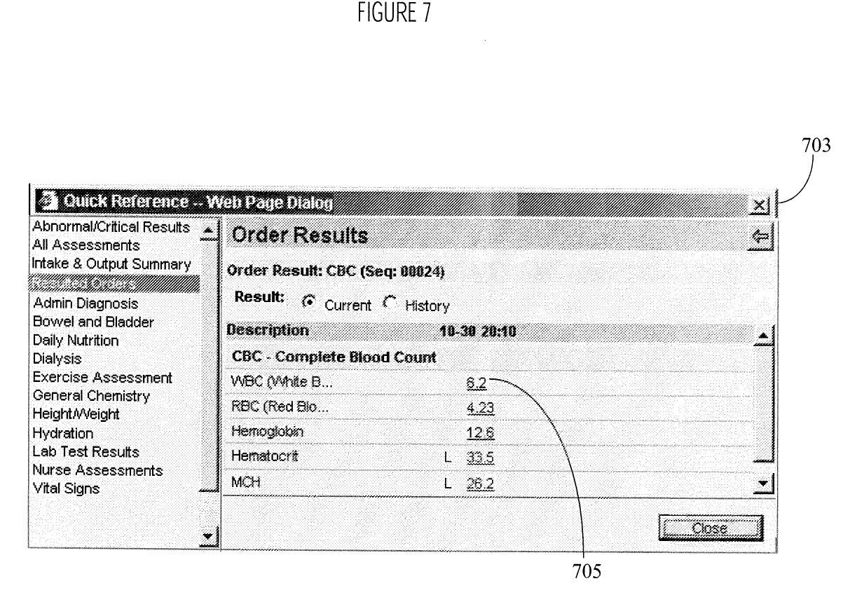

FIG. 6 shows user interface display configuration image 603 for configuring mini data views and a timeframe for Quick Overview display image quadrants. Specifically, display image 603 includes four quadrant boxes 605, 607, 609 and 611 advantageously located in relative positions corresponding to the relative positions of mini data views presented in a QO display image (e.g., quadrant mini data views 205, 207, 209 and 211 of FIG. 2) to provide a user-friendly way of configuring the QO display image quadrant mini data views. The four quadrant boxes 605, 607, 609 and 611 of configuration image 603 indicate selection of QO display image quadrant mini data views comprising assessments, abnormal/critical results, user-specified favorite assessments, and ordered laboratory test results, respectively. Box 613 enables a user to select a time duration over which data is presented in the abnormal/critical results mini data view and box 617 enables a user to select a time duration over which data is presented in the ordered laboratory test results mini data view. FIG. 7 illustrates an ordered laboratory test result mini data view presented in Quick Reference user interface pop-up image window 703. Image window 703 includes data acquired over a time duration selected using image 603 (FIG. 6).

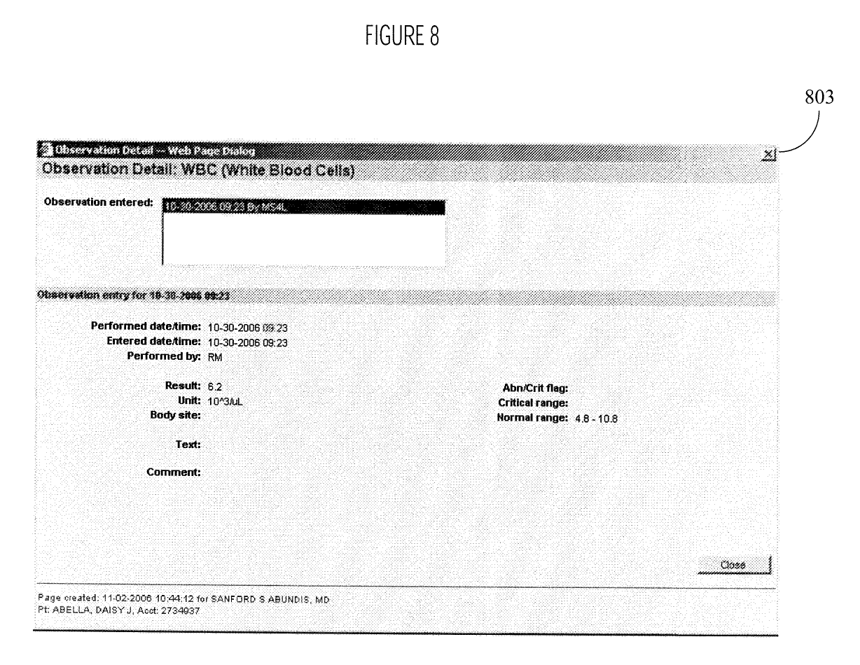

A quadrant mini data view provides user selectable functions in a QO display image, including enabling a user to toggle between current and historical data and navigate to access observation or laboratory test result detailed information. The user selectable functions are similarly available in a QR display image. FIG. 8 shows observation data mini data view 803 selected from a Quick Reference user interface pop-up image window. Specifically, white blood count detailed data in mini data view 803 is presented in response to user selection of white blood count item 705 in display image 703 (FIG. 7).

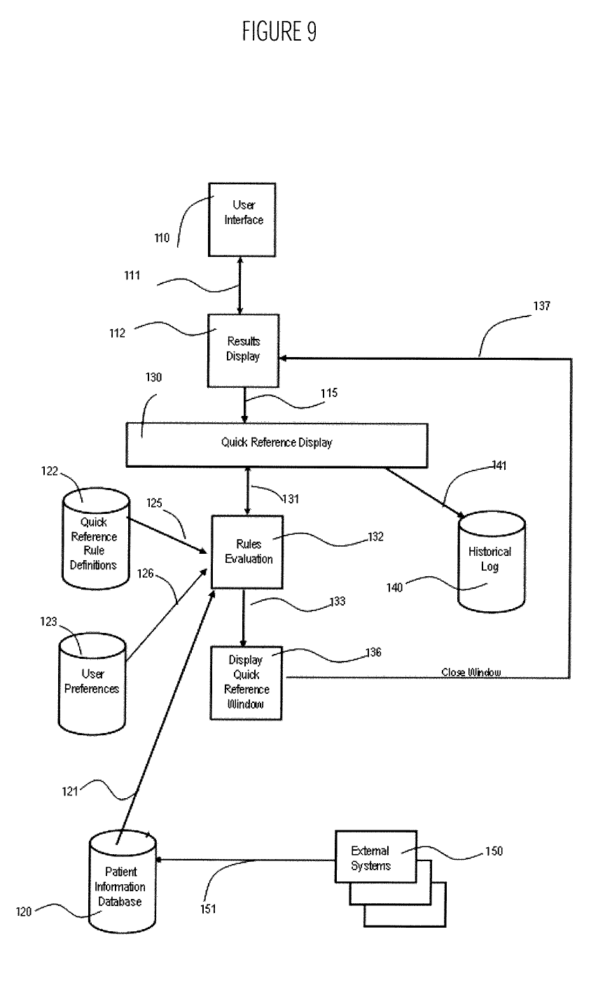

FIG. 9 shows a system for providing a Quick Reference mini-view of data in different image quadrants. A user (e.g., a physician) selects a patient via user interface 110 provided by user interface processor 26 (FIG. 1) and selects a laboratory test Results Display image 112 of user interface 110 through command 111. The user selects a Quick Reference Display QR application 130 through command 115 and selects a particular quick reference QR display image using QR application 130. In response to selection of the particular quick reference QR display image, the selection information is passed to Rules Evaluation subsystem 132 through interface 131. Rules evaluation subsystem 132 accesses Quick Reference Rules Definition database 122 through interface 125 to obtain specific rules associated with the selected particular quick reference QR display image. In response to acquisition of the specific rules from database 122, user preferences 123 are accessed through interface 126. User preferences 123 determine, for example, a time period for which information is to be displayed (such as number of hours, days, weeks, months), specific laboratory test results to display or omit and specific orders or activities to display. Rules evaluation subsystem 132 uses the rules and preferences obtained from databases 122 and 123 to adapt the selected particular quick reference QR display image to provide quick reference QR display image 136. Rules evaluation subsystem 132 incorporates desired data acquired from patient information database 120 through interface 121 into quick reference QR display image 136.

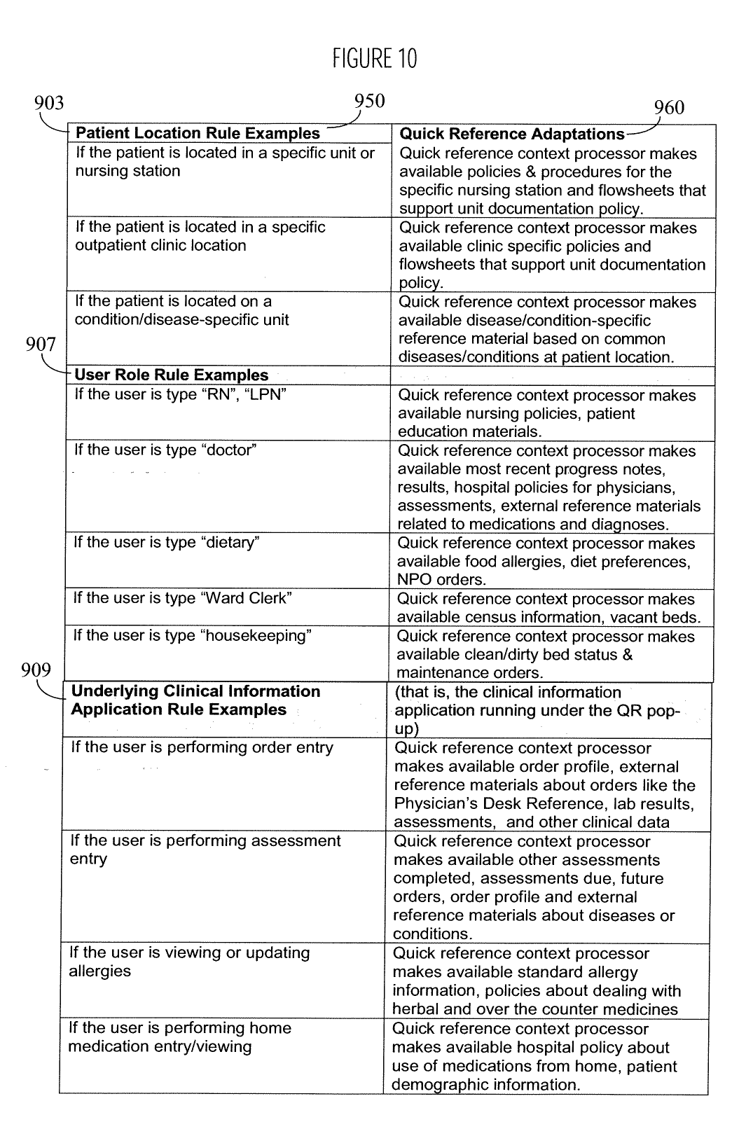

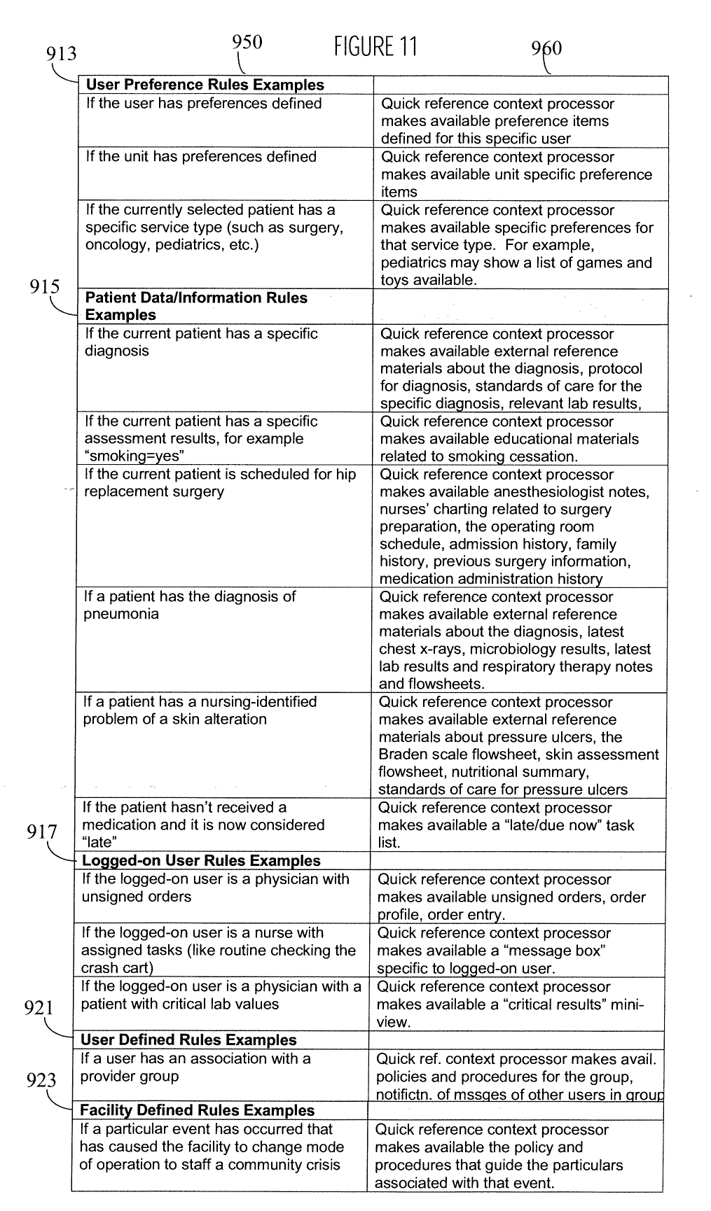

Rules evaluation subsystem 132 employs rules acquired from database 122. The rules are composed of a combination of data elements, including ordered laboratory test results (completed and scheduled), nursing interventions (completed and scheduled), diagnoses (single or a set), interdisciplinary problems, nursing problems, assessments, observations, and progress notes. Rules (as exemplified in FIGS. 10 and 11) are combined to produce more intelligent results for inclusion in QR display image 136. Rules determine laboratory test results to display or skip for a specific diagnosis, or for a specific set of diagnoses, or for a specific nursing problem, for example. Rules also determine laboratory test results to display or skip for a specific assessment or observation or for a specific set of assessments and/or observations. Similarly, rules also determine interventions to display or skip for a specific set of nursing problems and orders to display or skip for a specific interdisciplinary problem.

FIGS. 10 and 11 illustrate rules used for automatically adapting a display of data in Quick Reference mini-views comprising different image quadrants of a Quick Overview display image. The content of a QR display image is adapted as described in column 960 based on rules in column 950. The rules are grouped in categories including Patient Location Rules 903, User Role Rules 907, Underlying Clinical Information Application Rules 909, User Preference Rules 913, Patient Data/Information Rules 915, Logged-on User Rules 917, User Defined Rules 921 and Facility defined Rules 923.

Returning to FIG. 9, rules evaluation subsystem 132 executes acquired rules in processing data obtained from patient information database 120 through interface 121 to provide data for incorporation into quick reference QR display image 136 via interface 133. In response to information being displayed to the user in quick reference QR display image 136, the user may close QR display image 136. Once the user closes QR display image 136, the user is forwarded or redirected to laboratory test results display image 112 through command 137. If the display currently shows the laboratory test results display image 112, the QR application window is simply closed. Patient information database 120 also stores information received from external systems 150 (if present) through interface 151. Activities performed by QR application 130 are recorded in the historical log 140 through interface 141. Historical log 140 may be used to help satisfy the requirements of the Health Insurance Portability and Accountability Act (HIPAA).

In response to a user initiating execution of a QR application in user interface processor 26 (FIG. 1), a clinical information application in unit 51 sends identifier information (patient, facility, user, security identifiers) to context processor 25. Context processor 25 uses the identifier information to access at least one repository 17 to collect and display QR content in a QR display image. For example, a repository of patient information (e.g., repository 17 in FIG. 1, patient information database 120 in FIG. 9) stores data indicating patient medical diagnoses, patient problems, procedures, surgeries, laboratory test results, transcriptions, medications, orders, family history, medical history, assessment findings, allergies, home medications and demographics. Additional databases (e.g., in repository 17) store information indicating user preferences, user role, and hospital unit and facility information. A security processor within context processor 25 prevents a QR or QO display image showing any information items if a user is not authorized to see the information.

A QR display image may comprise a quadrant of a QO display image that incorporates flowsheet data (providing current and historical data), for example, and supports user navigation to detailed information. The QR and QO display images advantageously provides a similar look and feel to a user. Various embodiments of a QR display image use radio buttons or dropdown menus to make a selection of data for display and may use multi-quadrant pop-up windows (e.g., a pop-up version of a full QO display image) so that a physician may select more than one kind of data set to fill different window areas of an image. The QR application display image pop-up function may be embedded within an application. For example, there may be a static section of a display image that may be filled by a QR display image including different data that a clinician selects. This is useful to a clinician writing progress notes, for example, since the clinician may view desired data while writing a note and switch the content of the data displayed as needed. In clinical settings, the data sets may include data from previous encounters at the same hospital facility or may include data from different hospital facilities or different hospitals and/or across the duration of a patient lifetime record. The system enables a user to easily copy the displayed data into text fields, e.g., as unformatted text, and provides on-demand data review for use in clinical settings including inpatient, outpatient and long term care. The QR function is advantageously useful in any clinical setting.

FIG. 12 shows a flowchart of a process automatically performed by system 10 (FIG. 1) for providing a user with an adaptive view of patient-specific medical data during operation of an executable clinical information application. In step 812 following the start at step 811, context processor 25 automatically identifies context data associated with an executable clinical information application 51 being employed by a user. The context data includes an identifier of a patient, a user identifier, a medical condition of a particular patient, an identifier of a medical procedure received by the particular patient, an identifier of an operational location in clinical information application 51 associated with a displayed first image, demographic information of the patient and an identifier of a function of clinical information application 51 associated with the first image.

Configuration processor 15, in step 817, enables a user to enter preference data indicating preferred predetermined types of medical information to be displayed in multiple different types of reference display image window including a first window (e.g., a QO display image window) providing multiple static areas individually presenting corresponding different sets of patient medical data and a second window (e.g., a QR display image window) displayable as an overlay over images provided by clinical information application 51. Configuration processor 15 enables a user to indicate and customize preferred predetermined types of medical information to be displayed via the reference display image window to be specific to individual patients and different for individual patients. In step 819, system 10 stores in at least one repository 17, information provided by configuration processor 15, associating, for multiple different users, a user identifier with user specific preference data comprising preferred predetermined types of medical information to be displayed in a reference display image window for a particular user. The information stored in at least one repository 17 associates the medical condition and medical procedure identifier of the particular patient including of a medical procedure scheduled to be received by the particular patient, identifier of an operational location, the demographic information and the identifier of the clinical application function, with predetermined types of medical information to be displayed in the reference display image as an overlay. The information stored in at least one repository 17 also associates a diagnosis code associated with the medical condition of the particular patient and a text medical assessment of the particular patient with the predetermined types of medical information.

In step 822, user interface processor 26 employs at least one repository 17 for initiating generation of data representing a composite display image including and concurrently presenting at least one of (a) the first window (e.g., the QO display image window) and (b) the second window (e.g., the QR reference display image window) as an overlay of an image provided by clinical information application 51. User interface processor 26 initiates generation of data representing the composite display image, in response to user selection of an image element in the first (image) window. The first window presents in multiple different image areas, corresponding multiple different types of patient medical data pre-selected in response to user configuration data or selected in a default configuration. The first and second windows include predetermined types of medical information of a particular patient selected in response to a patient identifier and user identifier provided by context processor 25. User interface processor 26 adaptively generates data representing the reference display image window to include predetermined types of medical information associated with the operational location, demographic information and with the function of the clinical information application. The demographic information includes at least one of (a) patient gender, (b) patient height, (c) patient age and (d) patient weight. The reference display image window includes displayed user interface elements enabling user initiation of display of predetermined types of medical information of a particular patient automatically selected in response to a patient identifier and user identifier provided by context processor 25. The process of FIG. 12 terminates at step 825.

The systems and processes of FIGS. 1-12 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The QR function is usable in any field where users need access to a variety of data on demand for decision making, for example, insurance companies or industries using billing applications. The QR function and display image provides data on demand to clinicians when and where they need it, without interrupting decision making processes or workflow. It allows a clinician to select needed data and to view current, historical, and detailed information about the data. Because a QR display image popup window displays in the foreground (e.g., as an overlay) of a main application screen, clinicians can be doing a task and be able to view any kind of supporting data. The processes and applications may in alternative embodiments, be located on one or more (e.g., distributed) processing devices accessing a network linking the elements of FIG. 1. Further, any of the functions and steps provided in FIGS. 1-12 may be implemented in hardware, software or a combination of both and may reside on one or more processing devices located at any location of a network linking the elements of FIG. 1 or another linked network including the Internet.

What is claimed is:

1. A system for providing a user with an adaptive view of patient specific medical data during operation of an executable clinical information application, comprising:
a context processor for automatically identifying context data associated with an executable clinical information application being employed by a user, said context data including a patient identifier and a user identifier;
a configuration processor enabling a user to indicate preferred predetermined types of medical information to be accessible and displayed via a reference display image window;
at least one repository for storing information provided by said configuration processor, associating, for a plurality of different users, a user identifier with preferred predetermined types of medical information to be displayed in a reference display image window for a particular user; and
a user interface processor employing said at least one repository for initiating generation of data representing a composite display image including and concurrently presenting a first image provided by said clinical information application and a reference display image window as an overlay of said first image, said reference display image window including displayed user interface elements enabling user initiation of display of predetermined types of medical information of a particular patient automatically selected in response to a patient identifier and user identifier provided by said context processor.

2. A system according to claim 1, wherein
said context data includes an identifier of a medical condition of said particular patient and
said information stored in said at least one repository associates said medical condition of said particular patient with predetermined types of medical information to be displayed in said reference display image as said overlay.

3. A system according to claim 2, wherein
said information stored in said at least one repository associates a diagnosis code associated with said medical condition of said particular patient with said predetermined types of medical information.

4. A system according to claim 2, wherein
said information stored in said at least one repository associates a text or coded medical assessment of said particular patient with said predetermined types of medical information.

5. A system according to claim 1, wherein
said context data includes an identifier of a medical procedure received by said particular patient and
said information stored in said at least one repository associates said medical procedure identifier of said particular patient with predetermined types of medical information to be displayed in said reference display image as said overlay.

6. A system according to claim 5, wherein
said identifier of said medical procedure includes a medical procedure scheduled to be received by said particular patient.

7. A system according to claim 1, wherein
said context data includes an identifier of an operational location in said clinical information application associated with said first image and
said information stored in said at least one repository associates said identifier of an operational location with predetermined types of medical information to be displayed in said reference display image as said overlay.

8. A system according to claim 1, wherein
said context data includes an identifier of an operational location in said clinical information application associated with said first image and
said user interface processor adaptively generates data representing said reference display image window to include predetermined types of medical information associated with said operational location.

9. A system according to claim 1, wherein
said context data includes demographic information of said patient and
said information stored in said at least one repository associates said demographic information with predetermined types of medical information to be displayed in said reference display image as said overlay.

10. A system according to claim 1, wherein
said context data includes demographic information of said patient and
said user interface processor adaptively generates data representing said reference display image window to include predetermined types of medical information associated with said demographic information.

11. A system according to claim 9, wherein
said demographic information includes at least one of (a) patient gender, (b) patient height, (c) patient age and (d) patient weight.

12. A system according to claim 1, wherein
said context data includes an identifier of a function of said clinical information application associated with said first image and
said information stored in said at least one repository associates said identifier of said function with predetermined types of medical information to be displayed in said reference display image as said overlay.

13. A system according to claim 1, wherein
said context data includes an identifier of a function of said clinical information application associated with said first image and
said user interface processor adaptively generates data representing said reference display image window to include predetermined types of medical information associated with said function.

14. A system according to claim 1, wherein
said user interface processor initiates generation of data representing said composite display image in response to user selection of an image element in said first image.

15. A system according to claim 1, wherein
said first image presents in a plurality of different image areas, a corresponding plurality of different types of patient medical data pre-selected in response to user configuration data.

16. A system according to claim 1, wherein
said first image presents in a plurality of different image areas, a corresponding plurality of different types of patient medical data selected in a default configuration.

17. A system according to claim 1, wherein
said configuration processor enables a user to indicate preferred predetermined types of medical information to be displayed via said reference display image window and
said reference display image window includes said preferred predetermined types of medical information.

18. A system according to claim 1, wherein
said preferred predetermined types of medical information to be displayed via said reference display image window are patient specific and
said configuration processor enables a user to customize said preferred predetermined types of medical information to be displayed via said reference display image window to be specific to individual patients and different for individual patients.

19. A system for providing a user with an adaptive view of patient specific medical data during operation of an executable clinical information application, comprising:
a context processor for identifying context data associated with an executable clinical information application being employed by a user, said context data including an identifier of a patient and a user identifier;
a configuration processor enabling a user to enter preference data indicating preferred predetermined types of medical information to be displayed in a plurality of different types of reference display image window including a first window providing a plurality of static areas individually presenting corresponding different sets of patient medical data and a second window displayable as an overlay over images provided by said clinical information application;
at least one repository for storing information provided by said configuration processor, associating, for a plurality of different users, a user identifier and user specific preference data; and
a user interface processor employing said at least one repository for initiating generation of data representing a display image including at least one of, (a) said first window and (b) said second window as an overlay of an image provided by said clinical information application, said first and second windows including predetermined types of medical information of a particular patient selected in response to a patient identifier and user identifier provided by said context processor.
